(19) United States
(12) Patent Application Publication
(10) Pub. No.: US 2010/0025445 A1
(43) Pub. Date: Feb. 4, 2010

(54) THREE PIECE LIFTING DEVICE

(75) Inventors: SCOTT BRUNSON, WATERLOO, IA (US); TIM GUENTHER, Vinton, IA (US); SHAUN LINDERBAUM, Waterloo, IA (US)

Correspondence Address: ZARLEY LAW FIRM P.L.C., CAPITAL SQUARE, 400 LOCUST, SUITE 200, DES MOINES, IA, 50309-2350, US

(73) Assignee: AGS MARKETING, INC., Urbana, IA (US)

(21) Appl. No.: 12/184,402

(22) Filed: Aug. 1, 2008

(51) Int. Cl. B65G 7/12; A45F 3/14

(52) U.S. Cl. 224/579; 224/157; 224/259; 224/264

(57) ABSTRACT

A three piece lifting system for lifting loads such as furniture during a move. The system has a first elongated strap that has a plurality of loops at its first and second ends that receive second and third elongated straps. The second and third elongated straps each have shoulder loops that go on the shoulders of workers such that when assembled the first elongated strap engages the load so that the workers are enabled to lift the load off the ground.

### BACKGROUND OF THE INVENTION

This invention is related to lifting systems. More specifically, this invention is related to a three piece lifting system for moving furniture and the like.

Many pieces of equipment have been provided in an attempt to help individuals move furniture and their belongings during a move. Included is a hand dolly that can be placed under a piece of furniture such that an individual may roll the piece of furniture into a moving truck. While this allows one person to move furniture problems exist in that larger pieces of furniture are often too heavy for a single individual to handle using just a hand dolly. Additionally, problems with getting pieces of furniture in and out of doorways remain.

Another apparatus that has been used to help with individuals moving include several devices that use nylon straps that can be used between two individuals wherein the strap is placed underneath a piece of furniture and an individual at either end of the strap lifts the strap in order to lift the piece of furniture. A first type of system using straps can be seen in U.S. Pat. No. 6,729,511 to Dent, III. Described is a device that uses shoulder loops that can be worn by an individual wherein the shoulder loops are adjustably attached to a lift strap that can be placed underneath an object. This allows two people to move the furniture.

Despite some advantages problems remain with the Dent device. For example, the device is very expensive as the tension buckle that is utilized as an adjusting mechanism is complex. The buckle can also be a hazard that can swing and hit someone causing injury. Additionally, when going up stairs the strap tends to slip out of the buckle for the person on top because there is not adequate weight at the end to keep the locking mechanism engaged causing a safety hazard, especially to the individual at the bottom of the stairs.

A second type of strap system utilizes straps that criss-cross underneath a device and go on the forearms of an individual for lifting. Many problems are associated with this type of device as the device forces weight to be placed on one's forearms. Having weight distributed on a person's forearms is both bad for that individual's forearms and shoulders and arms and does not properly utilize a person's legs during lifting. This can cause many undesired injuries. Additionally, when using one's forearms to lift an object an individual's hands are not free to help balance and move the object. Further, oftentimes in use the object ends up being held at a high level that is difficult to balance thus also making for difficulties during the moving process.

Therefore, a principle object of the present invention is to provide a lifting system that is easy to adjust to ensure that a strap is centered.

Yet another object of the present invention is to provide an affordable lifting system.

Another object of the present invention is to provide a lifting system that minimizes risk of injury during lifting.

These and other objects, features, or advantages of the present invention will become apparent from the specification and claims.

### BRIEF SUMMARY OF THE INVENTION

A three piece lifting system having first, second and third elongated straps. The first elongated strap extends from a first end having a plurality of spaced apart loops to a second end that also has a plurality of spaced apart loops. The second elongated strap extends from a first end having a first shoulder loop to a second end having a second shoulder loop. The second elongated strap is disposed through one of the plurality of spaced apart loops at the first end of the elongated strap to connect the straps together. The third elongated strap also extends from a first end having a first shoulder loop to a second end having a second shoulder loop and is disposed through one of the plurality of spaced apart loops at the second end of the first elongated strap. Thus, the first elongated strap can be placed underneath and engage a load so that when two workers that are wearing a second and third elongated straps lift they are able to carry the load.

### BRIEF DESCRIPTION OF THE DRAWINGS

FIG. 1 is a side plan view of a three piece lifting system is use by workers;

FIG. 2 is a side plan view of the components of a three piece lifting system; and

FIG. 3 is a side plan view of an assembled three piece lifting system.

### DETAILED DESCRIPTION OF THE PREFERRED EMBODIMENT

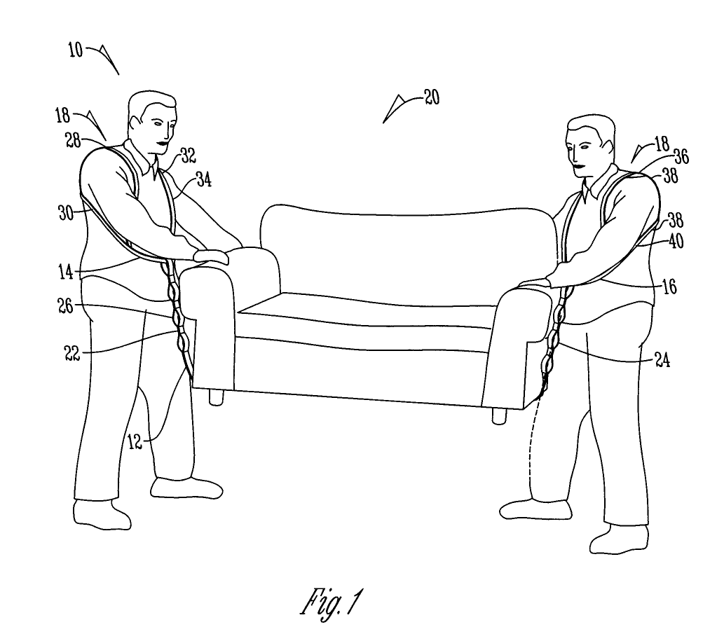

FIG. 1 shows a lifting system 10 having first, second, and third elongated straps 12, 14, and 16 that can be used by two workers 18 in order to lift a load 20. Each of the elongated straps 12, 14, and 16 are flexible straps that in one embodiment are made of a poly-propylene material. While in one embodiment poly-propylene may be used any other fabric that can constitute a strap such as nylon or the like that is flexible to accommodate a load 20 can be used without falling outside the scope of this invention. Also, while generically described as a load 20 the load 20 can represent any item that may need be moved or hauled by a worker such as a couch, dresser, desk, another piece of furniture or the like.

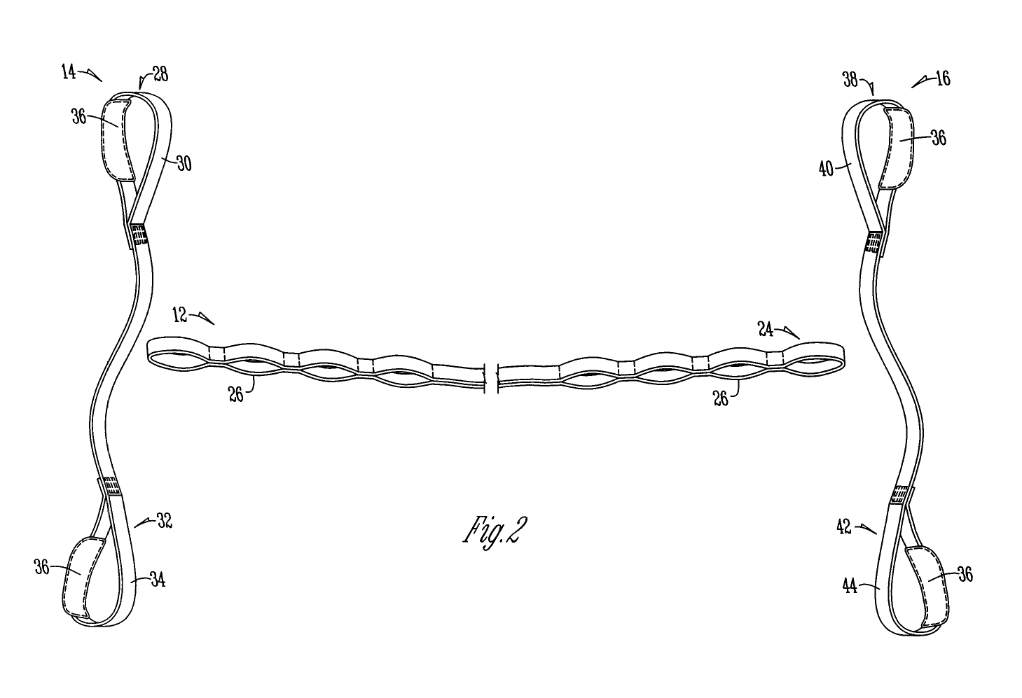

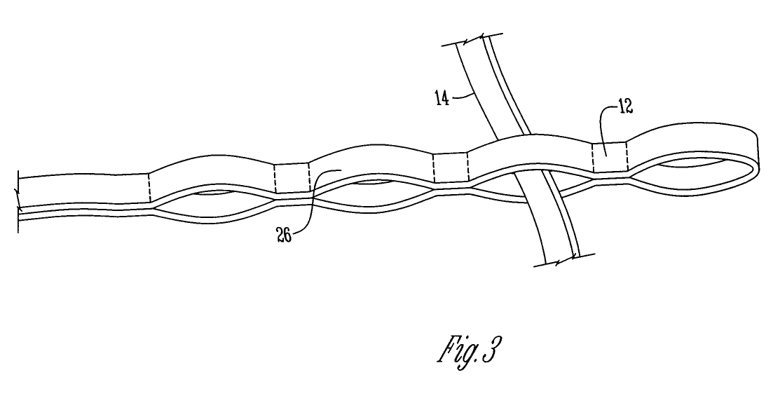

FIGS. 2 and 3 show the lifting system 10 wherein FIG. 2 shows the individual components of the lifting system 10. The first elongated strap 12 extends from a first end 22 to a second end 24. At the first and second ends 22 and 24 are a plurality of loops openings 26 that can receive the second and third elongated straps 14 and 16. The length of the first elongated strap 12 is adjustable depending on the size of load 20. Specifically, the second and third elongated straps 14 and 16 may be placed in different loop openings 26 to adjust to the proper size. The plurality of loop openings are evenly spaced from one another and the first and second ends 22 and 24 are symmetric to one another so that an individual can dispose the second and third elongated straps 14 and 16 through opposite loop openings 26 to ensure that the first elongated strap 12 is properly centered between the two workers 18 under the load 20. This prevents one worker 18 from bearing an unusually high load.

The second elongated strap 14 extends from a first end 28 that has a first shoulder loop 30 and extends to a second end 32 that has a second shoulder loop 34. The first and second shoulder loops 30 and 34 have a diameter greater than the diameter than the plurality of the loop openings 26 and are used to rest the second elongated strap 14 on the worker's shoulders. In one embodiment, each shoulder loop 30 and 34 have shoulder pads 36 wherein the shoulder pad 36 has a material that increases the friction between the pad 36 and the shoulder of the worker 18 minimizing the chance that the shoulder pad 36 slips off of the individual's shoulder causing the load 20 be dropped. In another embodiment the strap 14 may have a back brace or vest that can be worn by the workers 18. Either helps minimize the risk of injury.

The third elongated strap 16 is similar to the second elongated strap 14. Specifically, the third elongated strap 16 has a first end 38 with a first shoulder loop 40 and a second end 42 with a second shoulder loop 44. The third elongated strap 16 also can have shoulder pads 36 therein made of a material that increases the friction between the third elongated strap 16 and the shoulder of the worker 18. In one embodiment the strap 16 may have a back brace or vest that can be worn by the workers 18. Either helps minimize the risk of injury.

In operation, when an individual wants to move a load 20 such as a piece of furniture a worker 18 takes the first strap 12 and runs it underneath the load. Then, depending on the size of the load 20 the workers 18 determine which loop 26 of the plurality of loops the second and third elongated straps 14 and 16 should be disposed through for proper lifting. If the load 20 is symmetrical the workers 18 can choose symmetrically opposed loops 26 to ensure that the first elongated strap 12 is centered underneath the load 20 to ensure even lifting. Alternatively, if the load is not symmetrical and varied to one side the workers may offset which openings 26 they use in order to attempt to evenly distribute the weight of the load 20.

Once the second and third elongated straps 14 and 16 are in the desired openings 26 of the first elongated strap 12 the workers 18 bend and place the first and second shoulder loops 30, 34, 40 and 44 respectively on their shoulders and then lift in order to lift the load. In an embodiment wherein the second and third elongated straps 14 and 16 have shoulder pads 36 the shoulder pads create friction between the shoulders of the workers 18 and the shoulder loops 30, 34, 40 and 44 to ensure that the loops remain in place at all times. Once the load 20, or piece of furniture, has been moved to the correct location the second and third elongated straps 14 and 16 may be removed from the plurality of openings 26 within the first elongated strap 12. Then the elongated strap 12 may be removed for additional use.

Thus, presented is an improved lifting system 10. The lifting system 10 eliminates the need for expensive buckles and tensioning devices that not only cause the system to be more expensive but additionally present a hazard. Additionally, by using symmetrically opposed loops 26 a worker 18 can easily ensure that the first elongated strap is centered underneath a load 12 to provide for easy and quick lifting. Also, by utilizing shoulder loops an individual isolates and uses their leg muscles to lift minimizing the chances of injuries to an individual's back, arms, or forearms. The shoulder pads 36 also prevent slippage of the shoulder loops also presenting a safer system 10. Thus, at the very least all of the stated objectives have been met.

It will be appreciated by those skilled in the art that other various modifications could be made to the device without departing from the spirit and scope of this invention. All such modifications and changes fall within the scope of the claims and are intended to be covered thereby.

What is claimed is:

1. A three piece lifting system comprising:
a first elongated strap extending from a first end having a plurality of spaced apart loops to a second end having a plurality of spaced apart loops;
a second elongated strap extending from a first end having a first shoulder loop to a second end having a second shoulder loop and wherein the second elongated strap is disposed through one of the plurality of spaced apart loops of the first end of the first elongated strap;
a third elongated strap extending from a first end having a first shoulder loop to a second end having a second shoulder loop and wherein the third elongated strap is disposed through one of the plurality of spaced apart loops of the second end of the first elongated strap; and
wherein the first elongated strap engages a load so that two workers wearing the second and third elongated straps are enabled to carry the load.

2. The three piece lifting system of claim 1 wherein the first shoulder loop of the second elongated strap has a shoulder pad.

3. The three piece lifting system of claim 2 wherein the shoulder pad is made of a material that increases friction between the second elongated strap and a worker.

4. The three piece lifting system of claim 1 wherein the first elongated strap is centered under the load when the first elongated strap engages the load.

5. The three piece lifting system of claim 1 wherein the shoulder loops of the second and third elongated straps have a greater diameter than the plurality of loops at the first and second ends of the first elongated strap.

6. The three piece lifting system of claim 1 wherein the system is adjusted by disposing the second and third elongated straps through the plurality of loops at the first and second ends of the first elongated strap.

7. The three piece lifting system of claim 1 wherein the second and third elongated straps each have a back brace.
